(19) United States
(12) Patent Application Publication
(10) Pub. No.: US 2013/0248436 A1
(43) Pub. Date: Sep. 26, 2013

(54) LIQUID FILTER ASSEMBLY

(71) Applicant: DONALDSON COMPANY, INC., Minneapolis, MN (US)

(72) Inventors: John R. Hacker, Minneapolis, MN (US); David B. Harder, Burnsville, MN (US); Kenneth P. Skaja, Andover, MN (US)

(73) Assignee: DONALDSON COMPANY, INC., Minneapolis, MN (US)

(21) Appl. No.: 13/639,955

(22) PCT Filed: Apr. 11, 2011
(86) PCT No.: PCT/US11/31983

§ 371 Date: May 16, 2013

Related U.S. Application Data
(60) Provisional application No. 61/322,673, filed on Apr. 9, 2010.

(51) Int. Cl. F02M 37/22

(52) U.S. Cl. CPC F02M 37/22
USPC 210/457; 210/472

(57) ABSTRACT

A fluid filter element for use in fuel filtration systems is disclosed. The filter element comprises, in an example embodiment, top and bottom end caps; filter media extending between the end caps and forming a central volume between the end caps; and an inner liner disposed in the central volume of the filter media between the end caps. A fluid passage is positioned in the inner liner extending between the end caps, the fluid passage being separate and independent of the flow through the filter media. A first seal is affixed to the bottom end cap; and a second seal with a central opening is affixed to the lower end of the inner liner. The inner lining may provide partial axial support to the filter media. An outer lining may also be included and provide partial axial support to the filter media.

This application is being filed as a PCT International Patent application on Apr. 11, 2011, in the name of Donaldson Company, Inc., a U.S. national corporation, applicant for the designation of all countries except the U.S., and John R. Hacker, a U.S. Citizen; David B. Harder, a U.S. Citizen; and Kenneth P. Skaja, a U.S. Citizen, applicants for the designation of the U.S. only, and claims priority to U.S. Provisional Patent Application Ser. No. 61/322,673, filed Apr. 9, 2010, the contents of which is herein incorporated by reference.

### FIELD OF THE INVENTION

The present invention is directed to filter media for fluid filtration. In particular, the invention is directed to filter cartridges for liquid filtration, including liquid fuel filtration.

### BACKGROUND

Filtration of liquid fuels for use in internal combustion engines is often essential to proper engine performance. For example, various diesel engines currently use two separate fuel filter cartridges located in a top-load filter housing. A first filter is used to remove the majority of water and hard particles that can be found in the diesel fuel. The second filter is located downstream from the first filter and is used to remove the remaining water and smaller hard particles.

Each of these filter cartridges have features built into the cartridge that are designed to continuously remove any air that may be introduced into the fuel system during servicing of the filter cartridges or replacing fuel system components. These features built into the cartridges can include a single piece seal arrangement and an orifice that are used to pass air trapped in the fuel system back to the fuel tank where it can be vented back to atmosphere. The single piece seal arrangement is designed to seal in two separate locations while allowing air to pass between these two sealing locations by way of a small hole located between these two seal surfaces. This seal arrangement is located at the lower portion of the filter cartridge when installed in the filter housing.

One concern with this design is the possibility of plugging the small hole with contaminant that could be generated during the manufacturing process of the various components, particularly the seal arrangement or the plastic inner liner. It is known in the industry that injection molded plastic parts (i.e. inner liner) can have loosely attached pieces of plastic (known as “flash”) along the parting lines and witness lines of the part. These pieces can come off the liner during normal operation.

Because this seal arrangement is near the bottom of the filter cartridge, these pieces will collect in the same location as the small hole. In addition, the seal arrangement is made of an injection molded material where the small hole is formed during the molding process. The forming of this hole using this process creates the opportunity for flash to form at one end of the hole which can restrict flow. In some cases, the flash can form completely over the hole, closing off all flow.

In addition, current design requires that, during the assembly of the cartridge, the small hole in the seal arrangement line up with the outlet of the passage that is carrying the air. Any misalignment can completely block the air flow path.

Another issue with the current design is the design of the small vent orifices located on the top of the upper end cap. These orifices allow the air trapped in the filter housing to pass into the passage inside the inner liner, allowing the air to eventually reach the fuel reservoir where it will be vented to atmosphere. These orifice openings are extremely small and are located on a flat surface at the top of an extension which protrudes above the upper end cap. In the position in which the filter is located on the equipment, this surface is perpendicular to the direction of gravity. This design carries a risk that any small particle that is approaching the orifice may land on this surface and, with the help of gravity, remain there. Any lateral movement of the particle due to engine vibration could eventually move the particle into the entrance to the orifice, plugging it.

Therefore, a need exists for improved fuel filtration systems and methods that overcome the shortcomings of prior designs.

### SUMMARY OF THE INVENTION

The present invention is directed to filter media and filter cartridges. The present invention relates, in part, to a filter for fuel filtration to be used with diesel engines, although the same general configuration can be used for other fuels, such as gasoline.

Example embodiments of filter cartridges include a coalescing filter and a particle filter, both of which are described herein, without limitation. The filter media and cartridges reduce the chance of plugging the bleed air passage used in fuel filters.

In an example implementation, the invention is directed to a filter element for filtering liquids. The filter element includes a fluid passage configured to allow movement of air from a first end of the filter element to a second end of the filter element. A first seal is incorporated into the filter element; along with a second seal substantially concentric with the first seal. The second seal is also incorporated into the filter element. The first and second seals define first and second pathways, the first pathway configured and arranged for flow of liquids into or out of the filter, the second pathway configured and arrange for flow of gases out of the filter. Generally, first and second seals are coaxial but not co-planer.

In some implementations, the filter element further includes a first end cap and a second end cap, wherein the fluid passage connects the first and second end caps.

The filter element can further include filter media secured to, and extending between, the first and second end caps. In such implementations the extension of filter media defines an open central volume in fluid communication with the central aperture of the second end cap.

The filter element may comprise an inner liner disposed in the central volume of the filter media between the first and second end caps, the inner liner having at least one passage allowing fluid flow to pass radially through the filter media, through the passage in the inner liner, and into the central core of the inner liner.

In such implementations the first seal can be affixed to the second end cap and bounding the central opening therein, the first seal separating the fluid passage from the flow through the filter media and inner liner; and the second seal can be affixed to the lower end of the inner liner, wherein the central cavity is in fluid communication with the second end of the fluid passage.

The filter element can further comprise an outer liner disposed around the filter media, wherein the outer liner provides partial axial support and radial support to the filter media. Typically, the first and second seals comprise an elastomeric material.

The present invention provides a seal arrangement that incorporates two separate seals with a space between them. This design avoids the possibility of flash from either the injected molded plastic inner liner, or flash from the molded seal arrangement, from plugging the small hole by replacing it with a much larger opening. It also eliminates the misalignment issue, thereby improving the manufacturing process

In one embodiment, the filter element comprises: a first end cap comprising a vent orifice; and a second end cap comprising a central aperture, wherein the first and second end caps are positioned on opposite ends of the filter media; filter media secured to and extending between the first and second end caps, the filter media defining an open central volume in fluid communication with the central aperture of the second end cap; an inner liner disposed in the central volume of the filter media between the first and second end caps, the inner liner having at least one opening allowing fluid to flow out of the central volume of the media, radially through the open passage of the inner liner, and radially passing through the filter media; a fluid passage in the inner liner from a first end in fluid communication with the vent orifice, to a second end, the fluid passage being separate and independent of the flow through the filter media and the opening of the inner liner; a first seal affixed to the second end cap with a central opening therein, the first seal separating the fluid passage from the flow of fluids through the filter media and inner liner; and a second seal with a central opening affixed to the lower end of the inner liner, wherein the central opening is in fluid communication with the second end of the fluid passage.

The above summary of the present invention is not intended to describe each discussed embodiment of the present invention. This is the purpose of the figures and the detailed description that follow.

### FIGURES

The invention may be more completely understood in connection with the following drawings, in which:

FIG. 1 is an exploded view of a filter cartridge from a filter element constructed and arranged according to an embodiment of the present invention.

FIG. 2 is a vertical and a horizontal cross-sectional view of the inner liner of the filter cartridge of FIG. 1.

FIG. 3A is a perspective view of the components of a first end of the filter cartridge of FIG. 1.

FIG. 3B is a perspective view of a first end cap according to another embodiment of present invention.

FIG. 4 is a vertical cross-sectional view of the filter cartridge of FIG. 1.

FIG. 5 is a vertical cross-sectional view of the filter cartridge of FIG. 1 in a housing, showing the flow of fuel, of water, and of air within the cartridge.

FIG. 6 is an exploded view of a filter cartridge according to another embodiment of the present invention.

FIG. 7 is a vertical cross-sectional view of the inner liner of the filter cartridge of FIG. 6.

FIG. 8 is a perspective view of the components of an end of the filter cartridge of FIG. 6.

FIG. 9 is a vertical cross-sectional view of the filter cartridge of FIG. 6.

FIG. 10 is a vertical cross-sectional view of the filter cartridge of FIG. 6 in a housing, showing the flow of fuel, of water, and of air within the cartridge.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

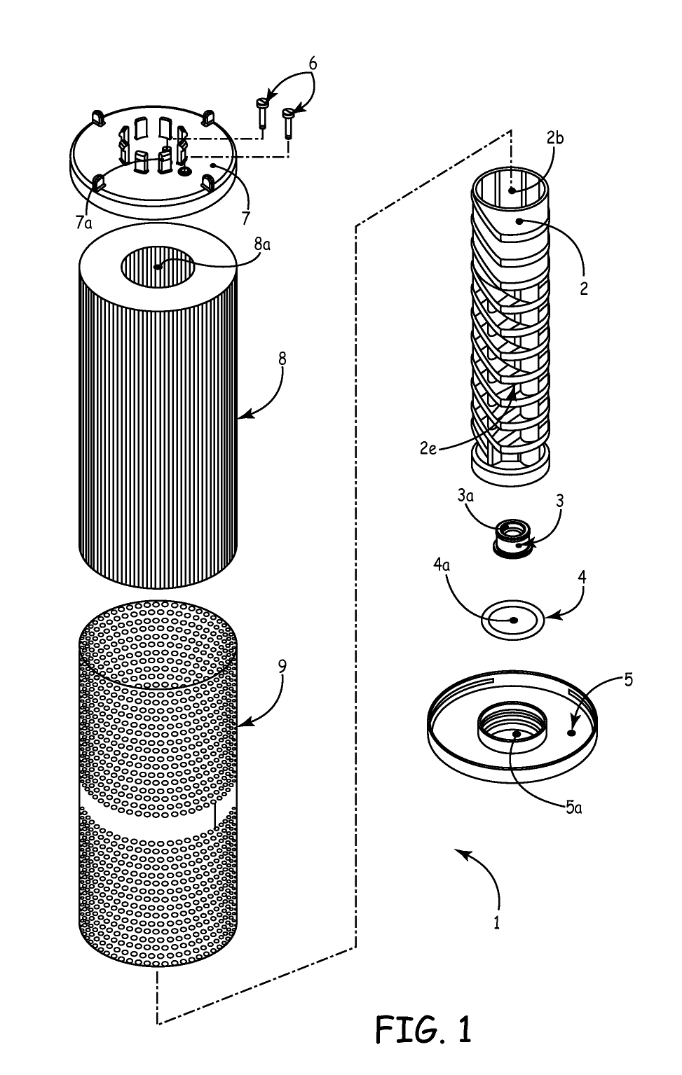

The invention is directed, in one implementation, to a filter element and components of a filter element suitable for fuel filtration. As shown in FIG. 1, in an example embodiment, the filter element 1 comprises an inner liner 2; a first seal 3; a second seal 4; a lower end cap 5; two vent inserts 6; an upper end cap 7; a media pack 8; and an outer liner 9. This filter, a coalescing filter, is designed to be a “reverse flow” filter. Typical flow through a filter cartridge moves in a radial direction through the filter media from the outside of the filter cartridge to the inside. A reverse flow filter flows radially through the media from the inside of the filter cartridge to the outside.

In the embodiment shown in FIG. 1, the coalescing filter element 1 comprises a first end cap 7, which contains a vent orifice 7a; a second end cap 5, comprising a central aperture 5a, wherein the first and second end caps 7, 5 are positioned on opposite ends of the filter media. An extension of filter media 8, or media pack, is secured to and extending between the first and second end caps. The filter media 8 defines an open central volume in fluid communication with the central aperture of the second end cap 5.

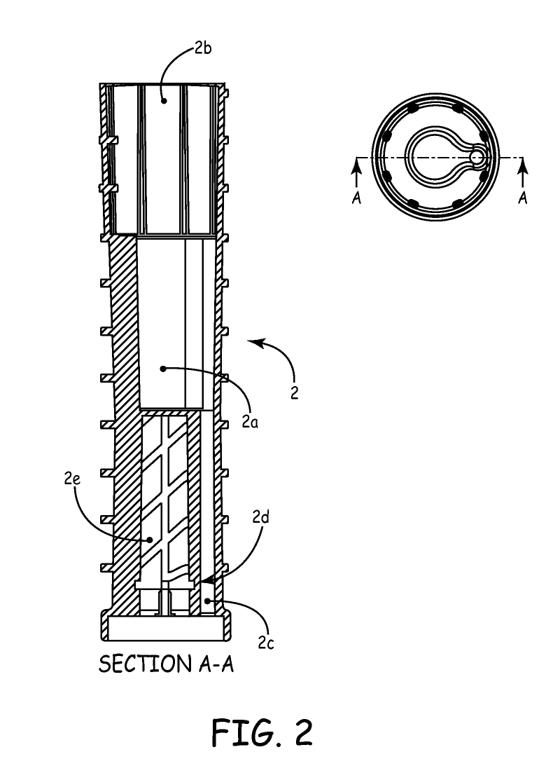

Inner liner 2 is disposed in the central volume of the filter media 1 between the first and second end caps 7, 5. The inner liner 2 has at least one opening 2e allowing fluid to flow out of the central volume of the media, through the open passage of the inner liner 2, and then passing through the filter media 1. The inner liner 2 also contains a fluid passage 2a from a first end in fluid communication with the vent orifice, to a second end (see FIG. 2). The fluid passage 2a is separate and independent of the flow through the filter media 1 and the opening 2e of the inner liner 2. A first seal 3 is affixed to the second end cap 5 with a central opening 3a therein, the first seal 3 separating the fluid passage from the flow of fluids through the filter media 1 and inner liner 2. A second seal 4, with a central opening 4a, is affixed to the lower end 2d of the inner liner 2, such that the central opening is in fluid communication with the second end of the fluid passage 2a (See FIG. 2).

The inner liner 2 provides several functions, illustrated in FIG. 2. It provides partial axial support to the media pack. It also incorporates a flow passage 2a, extending from end cap 5 to end cap 7, that is separate from the fuel that flows through a portion of the inner liner 2. One end 2b of this passage 2a receives trapped air from the air vent, which is located in the upper end cap. The other end 2c of the passage 2a delivers the air to a location between the first seal 3 and second seal 4, allowing the air to eventually travel to a reservoir. A relieved section 2d in the inner liner 2 allows the first seal 3 to affix itself to the inner liner 2. Finally, the inner liner 2 directs fluid coming into its center, outward through at least one opening 2e, and through the media pack 8 and outer liner 9.

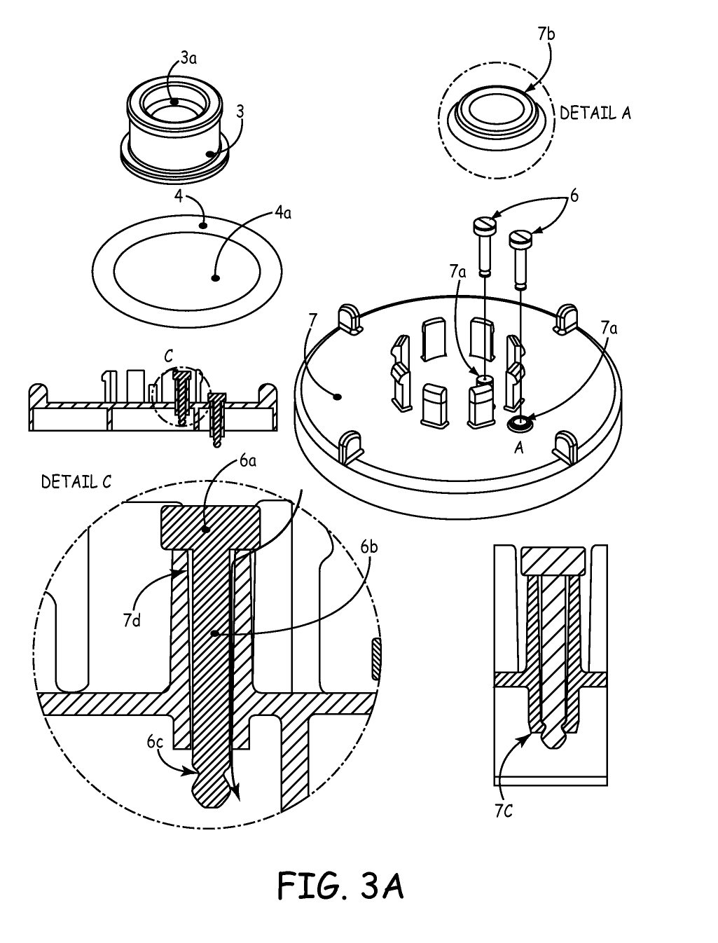

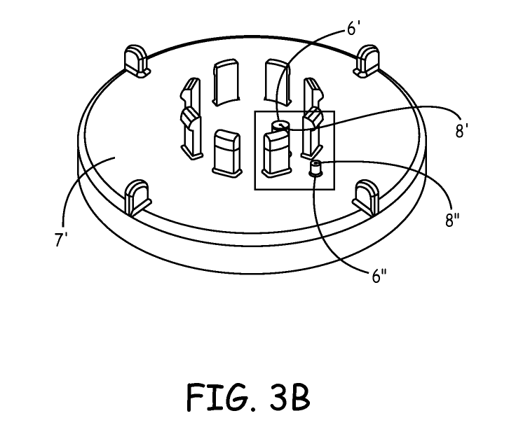

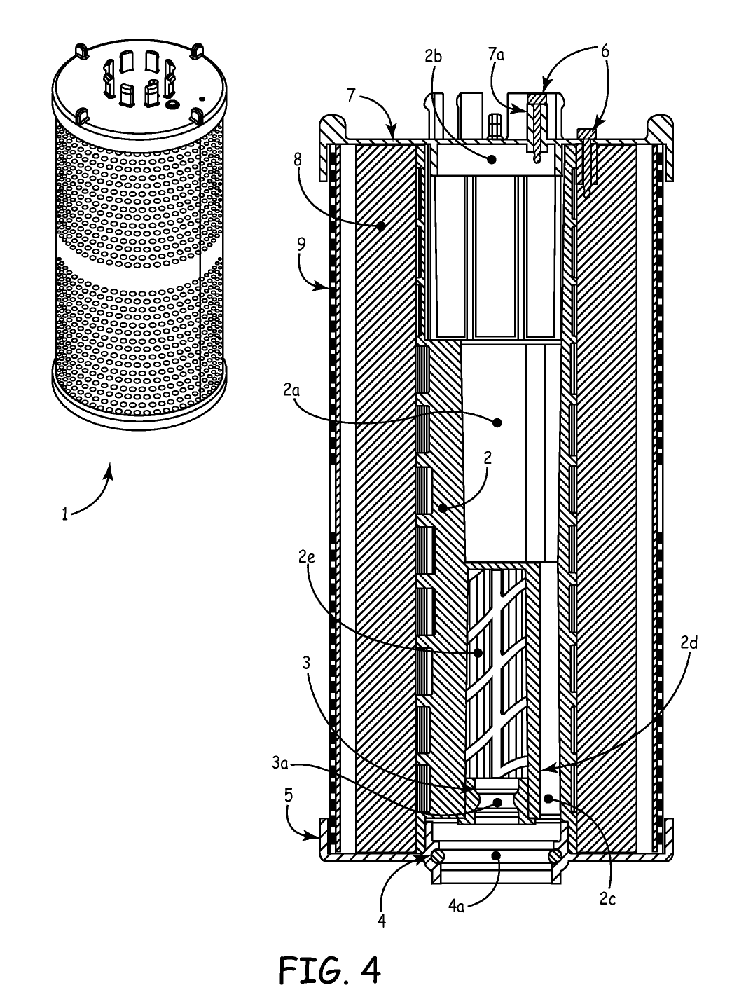

The first seal 3 of the filter cartridge 1, shown in FIGS. 3A and 4, receives, and seals onto, an inlet tube which supplies the fuel from the reservoir (not shown). Central opening 3a is located in the middle of the first seal for this purpose. The second seal 4 of the filter cartridge 1, shown in FIGS. 3A and 4, receives and seals a tube that is coaxial to the aforementioned tube. Like the first seal 3, the second seal 4 also has a central opening 4a. The annulus created between the outside diameter of the first tube and the inside diameter of the second tube is connected to a passage in the filter housing which ultimately is connected to the fuel reservoir.

The upper end cap 7 has two vent orifices 7a, shown in FIGS. 3A and 4, which work in conjunction with the vent inserts 6 to create an air vent flow path. The air vent flow path produces the proper restriction to allow air trapped in the fuel filter housing to be able to move to the fuel reservoir in a timely and efficient manner while restricting the amount of fuel flowing through the orifice once the trapped air is removed.

A vent insert 6 is fitted inside the vent orifice and held in place by a snap fit feature. The entrance 7b to the orifice is formed in the top surface of the vent orifice, providing the benefit of creating a flow direction through the entrance perpendicular to gravity, which allows more opportunity for a particle to move away from the orifice entrance and thereby reduce the chances of plugging the filter. The air flow path through the vent orifice can be seen in Detail C of FIG. 3. The insert has a head 6a and a tapered shaft 6b. Relief area 6c is located near the end of the tapered shaft 6b. The relief area 6c fits against a pair of tabs 7c to hold the insert in the vent orifice. The largest diameter of the tapered shaft is less than the smallest inside diameter 7d of the vent orifice, allowing a pathway for the airflow. The head of the insert is larger in diameter than the outside diameter of the vent orifice. As a result, the air flow coming from above the filter cartridge makes an approximate 90 degree turn (in the disclosed embodiment) allowing any particle, denser than air, to continue in the direction of gravity, which separates the particle from the flow stream further directing it away from the inlet.

An alternative configuration is shown in FIG. 3B. In FIG. 3B, upper end cap 7′ includes vents 6′ and 6″. Vents 6′ and 6′ provide orifices 8′ and 8″ at their ends, allowing gases to pass through but generally not allowing liquids to readily pass through when the filter cartridge is installed and in use. The orifices 8′ and 8″ do not contain vent inserts, as present in the embodiment shown in FIG. 3. In the alternative, the orifices 8′ and 8″ are small diameter openings that allow gases to pass through, but provide resistance to the flow of liquids.

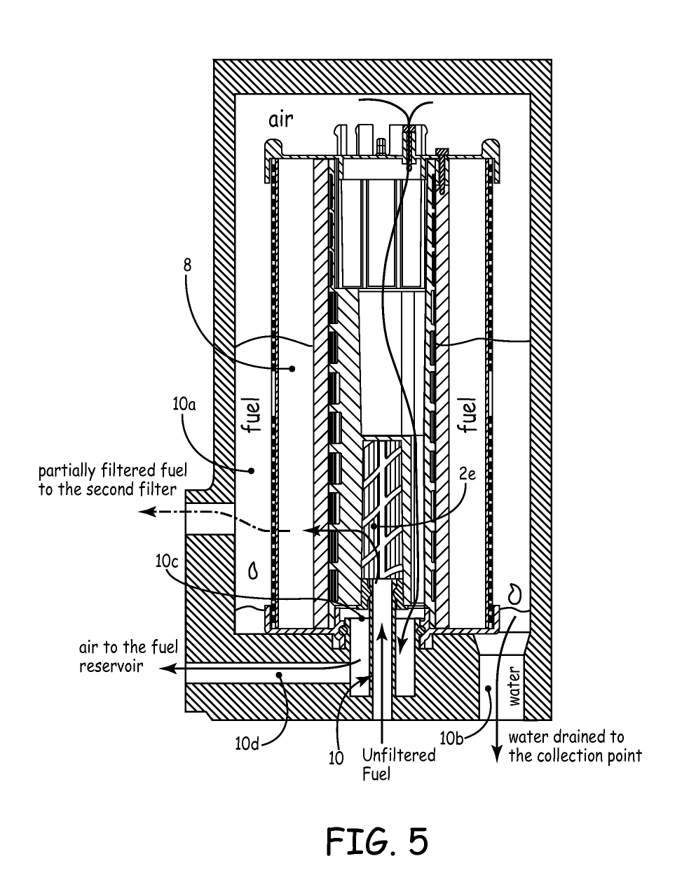

FIG. 5 shows the filter cartridge in an example housing. The housing may be shaped in any number of ways, and the housing of FIG. 5 is in not meant to be limiting. Rather, the housing in FIG. 5 is meant to illustrate the various flow paths. Unfiltered fuel is shown as a solid line starting near the bottom of the filter housing and moving upwards and to the left. The path of partially filtered fuel is shown as the dotted line. The path of air flow is shown as the solid line starting at the top of the filter and moving downwards and to the left. The water flow is shown by the solid line near the bottom right of the filter housing.

As shown in FIG. 5, unfiltered fuel enters through the passage at the bottom of the housing, passes through the inside diameter of the inlet tube 10, through an opening 2e in the inner liner 2, through the media pack 8, and into the annulus 10a between the outside diameter of the filter cartridge and the inside diameter of the housing. As the unfiltered fuel passes through the media pack 8, some of the hard particle contaminant is trapped in the media. Also, water in the fuel is coalesced from small droplets to large droplets. These large droplets come out of the media, into the annulus, and due to gravity (water has a higher specific gravity than the fuel) collect on the lower level of the housing. On the lower level of the housing is a drain port 10b that allows the water to leave the housing, after which it eventually finds its way to a final collection point.

When a replacement filter cartridge is first installed, there can be a considerable amount of air in the filter housing. As fuel is pumped into the housing, the fuel, being heavier than the air, starts to fill the bottom of the filter housing, forcing the air upward. FIG. 5 shows an interface line between the fuel and the air. As more fuel enters the housing, this interface line moves up, further compressing the air. The vent orifice in the upper end cap allows the trapped air to pass through the orifice 7a, through the flow passage 2a, through the open volume 10c between the first seal 3 and the second seal 4, and into the passage 10d leading out of the housing and into the fuel reservoir. Once the air is removed from the housing, fuel then takes that flow path. The orifice 7a, with its small open dimensions, ensures that only a very small amount of fuel is returned to the fuel reservoir.

In another embodiment, the filter of the present invention is a particle filter. The particle filter is designed to remove any remaining smaller particles and remaining coalesced water droplets. One important difference between the coalescing filter and the particle filter, as depicted in the shown embodiments, is the direction of flow. This cartridge is a “standard flow” design, which requires that the partially filtered fuel flows radially from the outside diameter of the media pack to the inside diameter of the media pack.

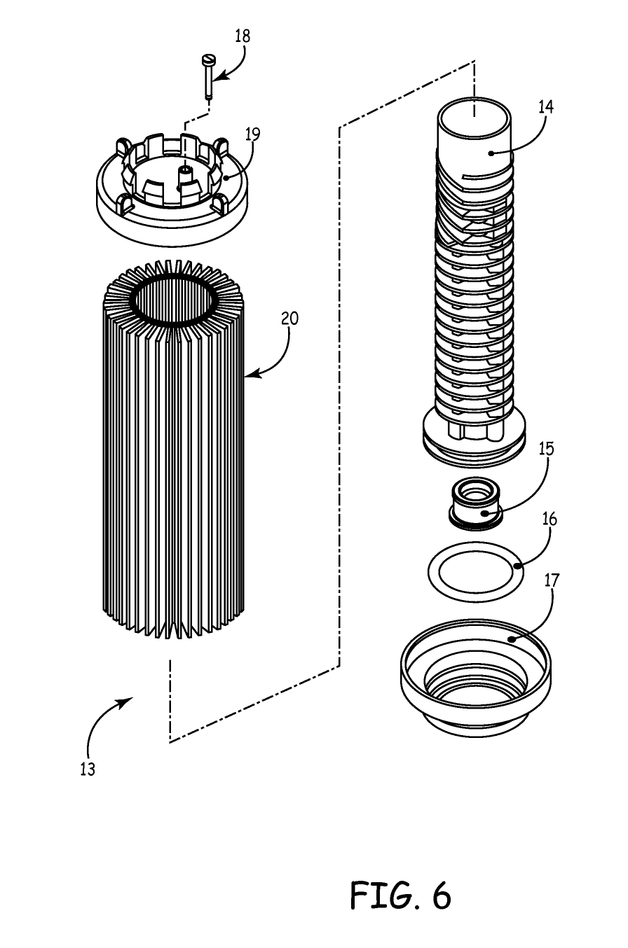

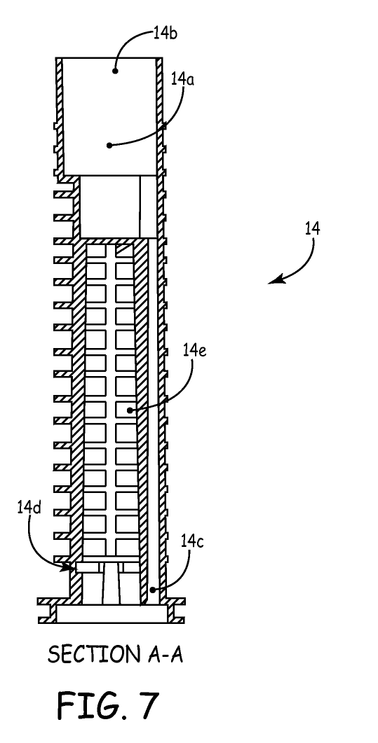

In one embodiment, shown in FIGS. 6 and 7, the filter element 13 comprises a first end cap 19. The first end cap 19 includes a vent orifice. The filter element 13 also includes a second end cap 17, comprising a central aperture, wherein the first and second end caps 19, 17 are positioned on opposite ends of the filter media 13; an extension of filter media 20, or media pack, secured to and extending between the first and second end caps 19, 17. The extension of filter media 20 defines an open central volume in fluid communication with the central aperture of the second end cap; an inner liner 14 disposed in the central volume of the filter media 13 between the first and second end caps 19, 17, the inner liner 14 having at least one passage 14e allowing fluid flow to pass radially through the filter media 13, flowing through the inner liner 14 into the central core of the inner liner 14.

The inner liner 14, shown in FIG. 7, provides several functions. It provides axial and radial support to the media pack, and it incorporates a flow passage 14a that is separate from the fuel that flows through a portion of the inner liner 14. A first end 14b of this passage receives the trapped air from the air vent which is located in the upper end cap. A second end 14c of the passage delivers air to a location between the first and second seal 15, 16, allowing the air to eventually travel to the reservoir. A relieved section 14d in the inner liner 14 allows a first seal 15 to affix itself to the inner liner 14. Finally, the inner liner 14 directs fluid radially through the media pack 20, at least one opening 14e, into the central area of the filter cartridge.

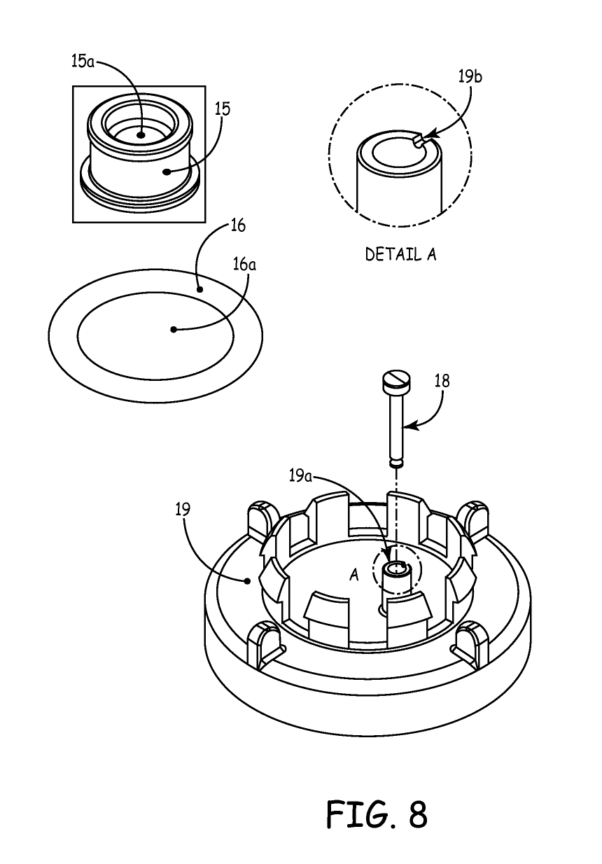

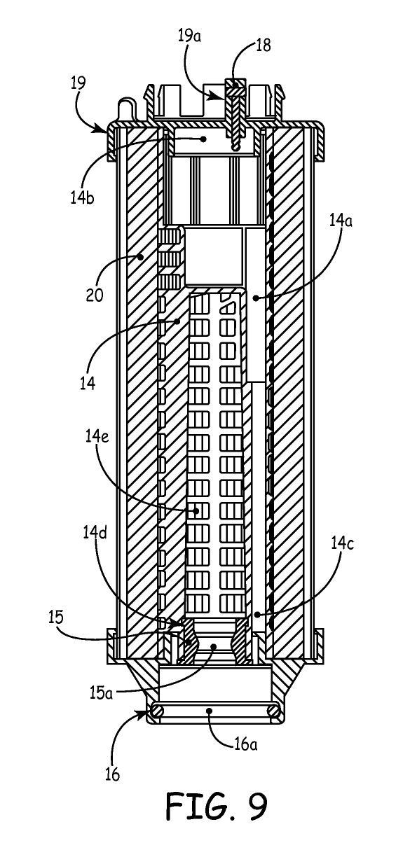

The first seal 15, shown in FIGS. 8 and 9, receives and seals on an inlet tube which supplies the fuel from the reservoir. A central opening 15a is located in the middle of the first seal 15. Also shown in FIGS. 8 and 9, the second seal 16, receives and seals itself to a tube that is coaxial to the aforementioned tube and also has a central opening 16a. The annulus formed between the outside diameter of the first tube and the inside diameter of the second tube is connected to a passage in the filter housing which ultimately is connected to the fuel reservoir.

The upper end cap 19 has a vent orifice 19a, which works in conjunction with the vent inserts 18 to create an air vent flow path producing the proper restriction to allow all the trapped air in the fuel filter housing to be able to move to the fuel reservoir in a timely manner while restricting the amount of fuel flowing through the orifice once all the trapped air is removed. The vent insert is fitted inside the vent orifice 19a and held in place by a snap fit feature. The entrance 19b to the orifice 19a is formed in the top surface of the vent orifice 19a, which provides the benefit of creating a flow direction through the entrance that is perpendicular to gravity (allowing more opportunity for a particle to move away from the orifice entrance thereby reducing the chances of plugging). A more detailed description of the vent orifice and vent insert is described with respect to FIG. 3A, with an alternative design shown in FIG. 3B.

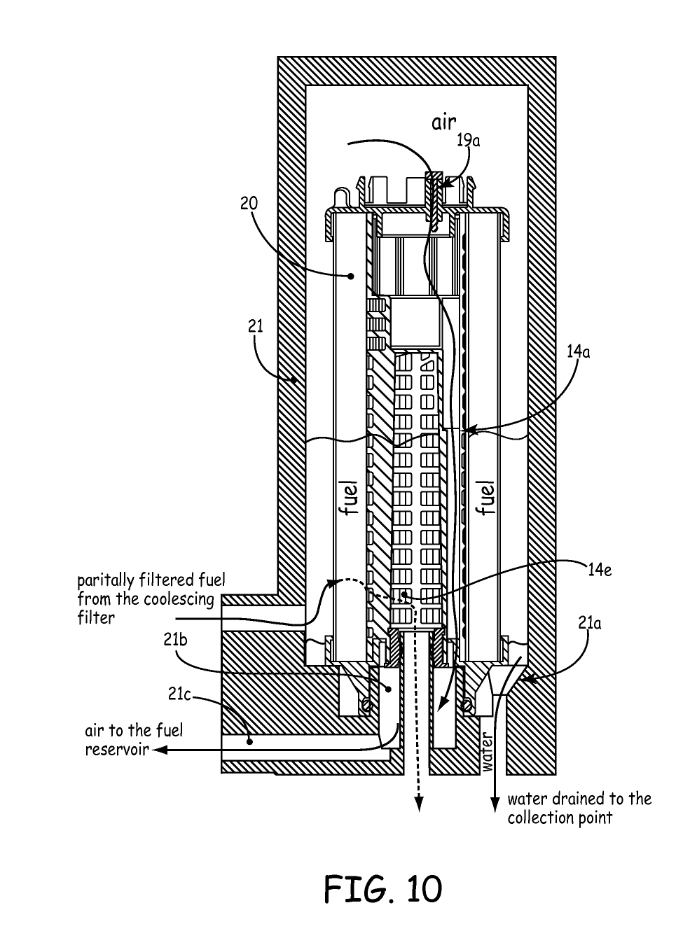

FIG. 10 shows one embodiment of the filter cartridge in a housing 21. The housing 21 shown in FIG. 10 is a representation of a housing for the purpose of illustrating the various flow paths. The partially filtered fuel is shown as the solid black line. The filtered fuel is shown as the dotted black line. The air and water are shown as additional solid lines. Unfiltered fuel enters through the side of the housing, radially passing through the media pack 20, through the opening 14e in the inner liner and into the central area of the cartridge.

As the unfiltered media passes through the media pack, the remaining hard particle contaminant is trapped in the media. Any water that entered the coalescing filter collects on the outside layer of media and, due to gravity, runs down to the lower portion of the housing. On the lower portion of the housing is a drain port 21a that allows the water to leave the housing, where it eventually finds its way to final collection point (not shown).

When a replacement filter cartridge is first installed, there can be a considerable amount of air in the filter housing. As fuel is pumped into the housing, the fuel, being heavier than the air, starts to fill the bottom of the filter housing, forcing the air upward. FIG. 10 shows an interface line between the fuel and the air. As more fuel enters the housing, this interface line moves up further compressing the air. The vent orifice in the upper end cap allows the trapped air to pass through the orifice 19a, through the flow passage 14a, through the open volume 21b between the first seal 15 and the second seal 16 and into the passage 21c leading out of the housing and into the fuel reservoir. Once the air is removed from the housing, fuel then takes that flow path. The orifice 19a ensures that only a very small amount of fuel is returned to the fuel reservoir.

It will be appreciated that, although the implementation of the invention described above is directed to fuel filtration, the present device may be used in other filtration applications, and is not limited to fuel filtration. In addition, while the present invention has been described with reference to several particular implementations, those skilled in the art will recognize that many changes may be made hereto without departing from the spirit and scope of the present invention.

We claim:

1. A filter element for filtering liquids, the filter element comprising:
a fluid passage configured to allow passage of air from proximate a first end of the filter element to proximate a second end of the filter element;
a first seal incorporated into the filter element; and
a second seal substantially concentric with the first seal, the second seal also incorporated into the filter element;
wherein the first and second seals define first and second pathways, the first pathway configured and arranged for flow of liquids into or out of the filter, the second pathway configured and arrange for flow of gases out of the filter.

2. The filter element of any of claim 1 and claims 3 to 8, further comprising a first end cap and a second end cap, wherein the fluid passage connects the first and second end caps.

3. The filter element of any of claims 1, 2 and claims 4 to 8, further comprising filter media secured to, and extending between, the first and second end caps,
wherein the filter media defines an open central volume in fluid communication with the central aperture of the second end cap.

4. The filter element of any of claims 1 to 3 and claims 5 to 8, further comprising an inner liner disposed in the central volume of the filter media between the first and second end caps, the inner liner having at least one passage allowing fluid flow to pass radially through the filter media, through the passage in the inner liner, and into the central core of the inner liner.

5. The filter element of any of claims 1 to 4 and claims 6 to 8, wherein:
the first seal is affixed to the second end cap and bounding the central opening therein, the first seal separating the fluid passage from the flow through the filter media and inner liner; and
the second seal is affixed to the lower end of the inner liner, wherein the central cavity is in fluid communication with the second end of the fluid passage.

6. The filter element of any of claims 1 to 5 and claims 7 and 8, further comprising an outer liner disposed around the filter media, wherein the outer liner provides partial axial support and radial support to the filter media.

7. The filter element of any of claims 1 to 6, and claim 8, wherein the first and second seals comprise an elastomeric material.

8. The filter element of any of claims 1 to 7, wherein the first and second seals are coaxial but not co-planer.

9. A filter element comprising:
a first end cap comprising a vent orifice;
a second end cap, comprising a central aperture, wherein the first and second end caps are positioned on opposite ends of the filter media;
filter media secured to, and extending between, the first and second end caps, the filter media defining an open central volume in fluid communication with the central aperture of the second end cap;
an inner liner disposed in the central volume of the filter media between the first and second end caps, the inner liner having at least one passage allowing fluid flow to pass radially through the filter media and into the central core of the inner liner;
a fluid passage in the inner liner extending from a first end, to a second end, the fluid passage being independent of the flow through the filter media and the frame of the inner liner;
a first seal affixed to the second end cap and bounding the central opening therein, the first seal separating the fluid passage from the flow through the filter media and inner liner; and
a second seal with a central cavity, located coaxial to the first seal, affixed to the lower end of the inner liner, wherein the central cavity is in fluid communication with the second end of the fluid passage.

10. The filter element of any of claim 9 and claims 11 to 15, wherein the inner lining provides partial axial support to the filter media.

11. The filter element of any of claims 9 to 10 and claims 12 to 15, further comprising an outer liner disposed around the filter media, wherein the outer liner provides partial axial support and radial support to the filter media.

12. The filter element of any of claims 9 to 11 and claims 13 to 15, wherein the first and second seals comprise an elastomeric material.

13. The filter element of any of claims 9 to 12 and claims 14 and 15, wherein the first and second seals are connected to each other.

14. The filter element of any of claims 9 to 13 and claim 15, wherein the first and second seals are coaxial and partially co-planer.

15. The filter element of any of claims 9 to 14, wherein the first and second seals are coaxial but non-planer.

16. A filter element for filtering liquids, the filter element comprising:
a first end cap comprising a vent orifice;
a second end cap, comprising a central aperture, wherein the first and second end caps are positioned on opposite ends of the filter media;
an inner liner between the first and second end caps, the inner liner having at least one opening allowing fluid to flow out of the central volume of the media, radially through the open passage of the inner liner, and substantially radially through the filter media;
a fluid passage in the inner liner from a first end in fluid communication with the vent orifice to a second end, the fluid passage being separate and independent of the flow through the filter media and the opening of the inner liner;
a first seal affixed to the second end cap with a central opening therein, the first seal separating the fluid passage from the flow of fluids through the filter media and inner liner; and
a second seal with a central opening affixed to the lower end of the inner liner, wherein the central opening is in fluid communication with the second end of the fluid passage.

17. The filter element of claim 16 or claim 18, wherein the inner lining provides partial axial support to the filter media.

18. The filter element of claim 16 or claim 17, further comprising an outer liner disposed around the filter media, wherein the outer liner provides partial axial support and radial support to the filter media.
